(19) United States
(12) Patent Application Publication
(10) Pub. No.: US 2005/0199075 A1
(43) Pub. Date: Sep. 15, 2005

(54) Sensor, magnetostrictive element, assisted bicycle and method for producing magnetostrictive element

(75) Inventors: Seigo Tokoro, Tokyo (JP); Teruo Mori, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/075,532

(22) Filed: Mar. 9, 2005

(30) Foreign Application Priority Data
Mar. 12, 2004 (JP) 2004-070861

(51) Int. Cl. G01L 3/02

(52) U.S. Cl. 73/862.333

(57) ABSTRACT

It is an object of the present invention to provide a sensor, a magnetostrictive element or the like having temperature stabilities. The sensor of the present invention for sensing a pedal pressure in an electric hybrid bicycle comprises a magnetostrictive element and a coil arranged on the outer circumferential side of the element, wherein the element is composed of a sintered body having a composition represented by TbₓDy₍₁₋ₓ₎T_{y}, wherein x is in the range: 0.50<x≦1.00, T represents one or more transition metal elements, and y is in the range: 1<y<4. The sensor of the above structure has temperature stabilities. The electric hybrid bicycle can stably generate an auxiliary force, when incorporated with the torque sensor.

### BACKGROUND OF THE INVENTION

1. Field of the Invention

The present invention relates to a sensor suitable for a torque sensor used in electric hybrid bicycles, a magnetostrictive element, and an assisted bicycle or the like which uses the magnetostrictive element.

2. Description of the Related Art

Recently, electric hybrid bicycles have been coming into wide use, where a motor generates an auxiliary force in response to a pedal pressure to assist in driving the bicycle. When the pedal of such an electric hybrid bicycle is pushed down by a user, the pedal pressure is sensed by a torque sensor. Based on the results, a motor generates corresponding auxiliary forces.

The torque sensor for these bicycles is required to be compact, light and highly responsive. Therefore, a supermagnetostrictive element (hereinafter referred to as magnetostrictive element), which shows a much higher response speed than a conventional piezoelectric element (e.g., refer to Kazushige Kakutani, Hideo Kawakami and Hideaki Aoki, “Development of electric hybrid bicycles using a supermagnetostrictive torque sensor”, Proceedings of the 16^{th} Annual Conference of the Robotics Society of Japan, 1193-1194 (1998)), is suitable for a torque sensor used in such an electric hybrid bicycle.

In a torque sensor using a magnetostrictive element, the magnetostrictive element undergoes a dimensional change when pedal pressure is applied from outside, thereby its permeability varies. The varied permeability is converted into an electrical signal which represents a pedal pressure by a coil arranged around the magnetostrictive element.

One of the magnetostrictive element for torque sensors has a composition represented by Formula (1) RT_{y}, wherein R represents one or more rare-earth metal elements, T represents one or more transition metal elements, and y is in the range: 1<y<4. In general, R is preferably Tb or Dy (e.g., refer to Japanese Patent Laid-Open No. 2003-3203 (page 4)).

### SUMMARY OF THE INVENTION

The conventional magnetostrictive elements developed so far have been dedicated mainly to actuators or the like. Therefore, the development efforts have focused on the properties of deformation in the elongation direction in response to electrical signals to secure a high magnetostrictive value.

Japanese Patent Laid-Open No. 2003-3203, for example, discloses that a starting alloy for magnetostrictive elements preferably has a composition represented by Formula (2) TbₐDy₍₁₋ₐ₎, wherein a is more preferably 0.27<a≦0.50. The alloy represented by Formula (3) TbₐDy₍₁₋ₐ₎T_{y} (wherein, T is preferably Fe) has a high saturation magnetostrictive constant and magnetostrictive value.

When applied to torque sensors, however, the above magnetostrictive element composition involves problems such that magnetostrictive properties becomes unstable as temperature changes.

For example, it has a greatly decreased inductance in a temperature range below room temperature (about 20° C.), with the result that the electrical signal generated in response to applied pedal pressure becomes unstable with temperature. The torque sensor, when used for electric hybrid bicycles, causes unfavorable phenomena, e.g., a smaller auxiliary force is generated at the same magnitude of pedal pressure, depending on ambient temperature conditions.

The present invention is developed to solve the above technical problems. It is an object of the present invention to provide a sensor, magnetostrictive element or the like which has temperature stabilities.

It is another object to provide an assisted bicycle which uses a sensor having temperature stabilities.

The sensor of the present invention comprises a magnetostrictive element and coil arranged on the outer circumferential side of the element, wherein the element comprises a sintered body having a composition represented by TbₓDy₍₁₋ₓ₎T_{y} (here, x is in the range: 0.50<x≦1.00, T represents one or more transition metal elements, and y is in the range: 1<y<4).

A power can be stabilized less sensitive to temperature change by keeping the compositional ratio x of Tb contained in the magnetostrictive element at 0.50<x≦1.00.

The sensor is particularly suitable for those types in which the coil generates an electrical signal in response to an external force working in such a direction as to compress the magnetostrictive element, e.g., torque and pressure sensors. It is particularly preferable to use the sensor as a torque sensor which senses a pedal pressure in electric hybrid bicycles.

Another aspect of the present invention is a magnetostrictive element by itself. It is composed of a sinter having a composition represented by TbₓDy₍₁₋ₓ₎T_{y}, wherein x is in the range: 0.50<x≦1.00, T represents one or more transition metal elements, and y is in the range: 1<y<4.

Still another aspect of the present invention is an assisted bicycle. It comprises a bicycle body driven by a pedal pressure, sensor which generates an electrical signal in response to the pedal pressure, and auxiliary force generator which generates an auxiliary force in response to the electrical signal transmitted from the sensor for driving the bicycle body. The sensor comprises a magnetostrictive element and signal generating member, wherein the magnetostrictive element has a composition represented by TbₓDy₍₁₋ₓ₎T_{y} (here, x is in the range: 0.50<x≦1.00, T represents one or more transition metal elements, and y is in the range: 1<y<4) and varies in permeability on receiving a pedal pressure as a compressive force, and the signal generating member generates an electrical signal in accordance with the varied permeability of the magnetostrictive element.

The devices for the auxiliary force generator include an electric motor, but not limited thereto, needless to say, and other driving sources can be used.

A method for producing a magnetostrictive element is still another aspect of the present invention. It comprises steps of compacting a starting material powder into a shape in a magnetic field to prepare a compact, and of sintering the compact to prepare a sintered body having a composition represented by TbₓDy₍₁₋ₓ₎T_{y} (here, x is in the range: 0.50a<x≦1.00, T represents one or more transition metal elements, and y is in the range: 1<y<4).

The present invention provides a sensor comprising a magnetostrictive element whose inductance changes to a limited extent with varied temperature to stably generate power by keeping the compositional ratio x of Tb contained in the magnetostrictive element at 0.50<x≦1.00. The sensor allows an assisted bicycle in which it is used to stably keep a generated auxiliary force, because of suppressed changes in auxiliary force with ambient conditions.

### BRIEF DESCRIPTION OF THE DRAWINGS

FIG. 1 structurally illustrates one embodiment of the torque sensor of the present invention;

FIG. 2 structurally illustrates one embodiment of the bicycle equipped with an electric-powered assist;

FIG. 3 shows the inductance measurement results, where a load of 0 to 80 kg is applied to the magnetostrictive element prepared in EXAMPLE 1;

FIG. 4 shows the inductance measurement results, where a load of 0 to 240 kg is applied to the magnetostrictive element prepared in EXAMPLE 1;

FIG. 5 shows the relationship between variation of inductance and ambient temperature at a Tb compositional ratio x of 0.28;

FIG. 6 shows the relationship between variation of inductance and ambient temperature at a Tb compositional ratio x of 0.30;

FIG. 7 shows the relationship between variation of inductance and ambient temperature at a Tb compositional ratio x of 0.32;

FIG. 8 shows the relationship between variation of inductance and ambient temperature at a Tb compositional ratio x of 0.34;

FIG. 9 shows the relationship between variation of inductance and ambient temperature at a Tb compositional ratio x of 0.40;

FIG. 10 shows the relationship between variation of inductance and ambient temperature at a Tb compositional ratio x of 0.60;

FIG. 11 shows the relationship between variation of inductance and ambient temperature at a Tb compositional ratio x of 1.00; and

FIG. 12 shows the relationship between temperature characteristic coefficient P and compositional ratio x of Tb.

### DETAILED DESCRIPTION OF THE PREFERRED EMBODIMENTS

The present invention is described in more detail by the embodiments illustrated by the drawings.

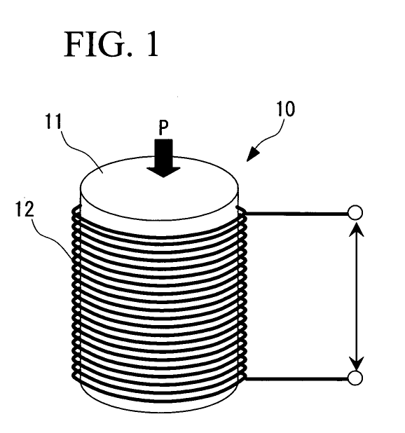

FIG. 1 structurally illustrates a torque sensor (sensor) 10 according to one embodiment of the present invention. As shown, the torque sensor 10 comprises, e.g., a columnar magnetostrictive element 11 and a coil (signal generating member) 12 which is wound around the magnetostrictive element 11.

In the torque sensor 10, the magnetostrictive element 11 contracts in the axial direction, on receiving an external compressive force P acting on the element 11 in the axial direction. This varies its permeability, and the coil 12 generates an electrical signal in response to the varied permeability.

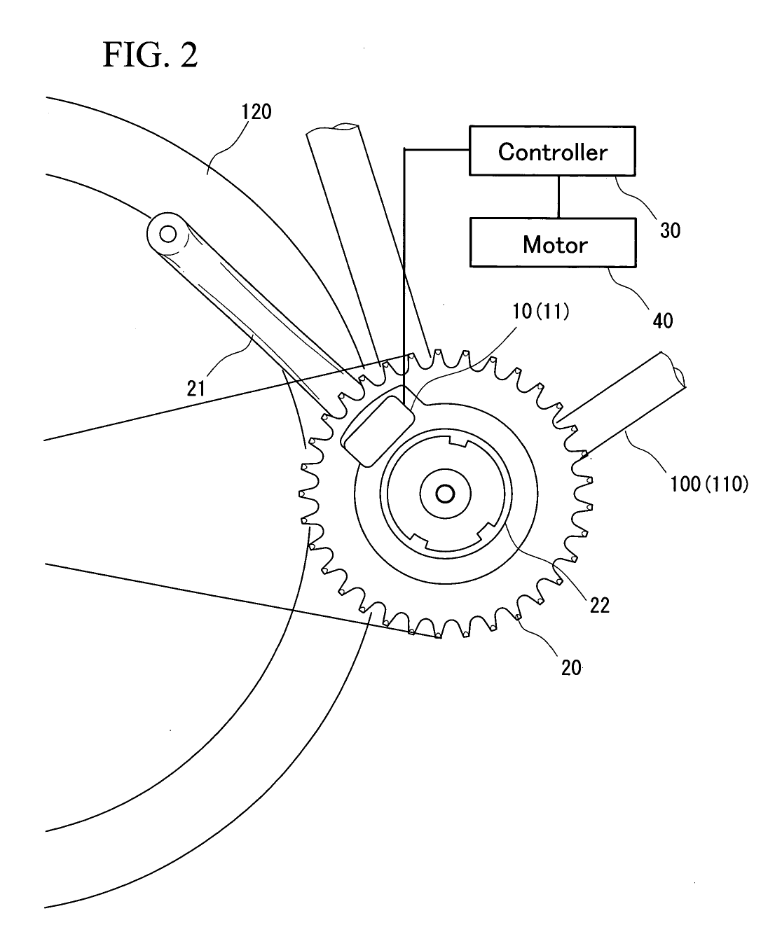

FIG. 2 illustrates the torque sensor 10 incorporated into a crank member 20 for an electric hybrid bicycle 100 (assisted bicycle). When a pedal 21 is treadled, the resulting pedal pressure acts on the magnetostrictive element 11 for the torque sensor 10 via a slip ring 22. Then, the torque sensor 10 generates an electrical signal in response to the pedal pressure. The controller 30, on receiving the electrical signal, controls a motor (auxiliary force generator) 40 such that the motor 40 generates an auxiliary force in response to the electrical signal and assists rotation of a wheel 120, thus augmenting the driving force for the body 110 of the electric hybrid bicycle 100.

The magnetostrictive element 11 is obtained by sintering an alloy powder having a composition represented by Formula (1) RT_{y} (wherein, R is one or more rare earth elements, T is one or more transition metal elements and 1<y<4).

R is at least one selected from rare earth elements of lanthanoids and actinoids, where the rare earth elements represent a concept including Y. Of these elements, Nd, Pr, Sm, Tb, Dy and Ho are particularly preferable as R, and Tb and Dy are more preferable. They may be used in combination.

T is at least one selected from transition metal elements. Of these, Fe, Co, Ni, Mn, Cr and Mo are particularly preferable as T, and Fe, Co and Ni are more preferable. Fe, Co and Ni may be used in combination.

In the alloy represented by the Formula (1) RT_{y}, 1<y<4. RT₂ (RT_{y} with y=2) as a laves type intermetallic compound is suitable for the magnetostrictive element 11 because of its high Curie temperature and high magnetostrictive value. When y is 1 or less, the R-rich phase deposits in the alloy during heat treatment which follows sintering and leads to decrease its magnetostrictive value. When y is 4 or more, on the other hand, the RT₃ or RT₅ phase increases also leads to decrease a magnetostrictive value of the alloy. It is therefore preferable to keep the relationship 1<y<4 to increase the RT₂ phase, more preferably 1.5≦y≦2.0, still more preferably 1.80≦y≦1.95. R may be a mixture of rare earth elements, in particular, a mixture of Tb and Dy is preferable.

In Formula (2) TbₓDy₍₁₋ₓ₎, which represents the alloy composition for the present invention, it is essential that the compositional ratio a is in the range: 0.50<x≦1.00. When x is in the above range, the alloy represented by Formula (3) TbₓDy₍₁₋ₓ₎T_{y} can show temperature stabilities such that changes in inductance with temperature is small. When x is 0.5 or less, the magnetostrictive element 11 incorporated in a sensor such as the torque sensor 10 varies in inductance with ambient temperature, in particular in a low temperature region.

The compositional ratio x may be 1.00, by which is meant that the alloy contains no Dy. The alloy can have improved orientation and a higher magnetostrictive value, when incorporated with Dy at a given content. However, in the case of torque sensor or the like, where more importance is placed on displacement of the magnetostrictive element in such a direction as to compress the magnetostrictive element 11 than on magnetostrictive value, Dy content can be decreased. Moreover, the magnetostrictive element 11 may contain no Dy depending on required properties of the torque sensor 10. The torque sensor 10 can have sufficiently higher properties, e.g., speed of response, even in the above case, than a conventional one incorporated with a piezoelectric element or the like, needless to say.

The compositional ratio x is preferably 0.50<x≦0.75.

As T, particularly Fe is prefereable, which forms with Tb or Dy an intermetallic compound ((Tb, Dy) Fe₂) having a high magnetostrictive value and high other magnetostrictive properties. Fe may be partly substituted by Co or Ni. In this case, however, Fe preferably accounts for 70% by weight or more, more preferably 80% or more, because Co decreases permeability although increasing magnetic anisotropy, while Ni decreases Curie temperature to decrease magnetostrictive value at room temperature and in a high magnetic field.

The alloy powder as a starting material is preferably treated to absorb hydrogen partially or totally. The alloy powder, when absorbs hydrogen, produces a strain in the particles that constitute the powder, the resulting internal stress cracking the particles. The particles in the mixture are cracked into fractions, when exposed to pressure during the compacting step, and the resulting compact can be sintered more densely. Rare earth metal elements, e.g., Tb and Dy, are easily oxidated, and coated with an oxide film of high melting point in the presence of oxygen even in a trace quantity, to retard sintering. They are more resistance to oxidation, when absorb hydrogen. Therefore, the alloy powder can be sintered more densely, when treated to absorb hydrogen partially or totally.

The hydrogen-absorbing starting material preferably has a composition represented by Formula (4) Dy_{b}T_{(1-b)} with b satisfying the relationship of 0.37≦b≦1.00. T may be Fe itself or Fe partly substituted by Co or Ni. This allows the starting alloy powder to be sintered more densely.

In this embodiment, the starting material powder is sintered in a mixed hydrogen/inert gas atmosphere with the relationship of hydrogen gas:argon (Ar) gas=X:100−X (Formula 5) with X (vol %) satisfying 0<X<50. The mixed hydrogen/inert gas atmosphere is provided in a heating-up period in a range of 650° C. or higher or/and in a stable temperature range of 1150 to 1230° C., inclusive.

For the alloy represented by Formula (1) RT_{y}, the starting material powder is placed in the mixed hydrogen/inert gas atmosphere at least in a heating-up period at 650° C. or higher.

The compact of the starting material powder is heated at 3 to 20° C./minute in a furnace for sintering. At below 3° C./minute, productivity will go down. At above 20° C./minute, on the other hand, atoms in starting material powder insufficiently diffuse to cause problems, e.g., segregation or formation a dissimilar phase. The reason to set the temperature range for the above mixed hydrogen/inert gas atmosphere at 650° C. or higher is to avoid the decrease in magnetostrictive value caused by the absorption of hydrogen, since hydrogen is easily absorbed under such a low temperature below 650° C.

It is preferable to sinter the compact for a period in which temperature is essentially kept at a constant level. The stable temperature is preferably in a range of 1150 to 1230° C. At below 1150° C., the sintering is not progressed and thereby the grain size of the main phase is decreased to have a lower magnetostrictive value. At above 1230° C., on the other hand, which is near a melting point of the alloy represented by RT_{y}, melting of the sintered body may occur.

R readily reacts with oxygen to form a stable rare earth oxide, which little exhibits magnetic properties for a practical magnetic material. Oxygen, although present at a very low content in a sintering atmosphere, can greatly deteriorate magnetic properties of the sintered body prepared at high temperature. Therefore, heat treatment such as sintering is carried out preferably in a hydrogen-containing atmosphere. Oxidation is also controlled in an inert gas atmosphere, but an inert gas alone is difficult to completely remove oxygen, allowing it to react with a rare earth element, which is highly reactive with oxygen, to form the oxide. Therefore, the sintering atmosphere is preferably of a hydrogen/inert gas mixture to prevent the oxidation of rare earth element.

For a hydrogen gas-containing reducing atmosphere, X (vol %) preferably satisfies 0<X<50 in Formula 5 of hydrogen gas:argon (Ar) gas=X:100−X. An Ar gas is inert and does not oxidize R. Therefore, it can form a reducing atmosphere when mixed with hydrogen gas. In order to obtain a reducing atmosphere, X (vol %) preferably satisfies 0<X. At 50≦X, the reducing atmosphere is saturated. Therefore, X<50 is preferable. It is preferable to keep a mixed hydrogen/Ar gas atmosphere during the heating-up carried out at 650° C. or higher. It is more preferable to keep the mixed hydrogen/Ar gas atmosphere in the stable temperature range.

Flow of the magnetostrictive element production process will be described in detail below.

First, Tb, Dy and Fe are weighed and then melted in an inert gas atmosphere of Ar to prepare the alloy (hereinafter referred to as Starting Material A) as one of starting materials. Starting Material A has a composition of Tb_{0.4}Dy_{0.6}Fe_{1.94}, for example. The Starting Materials A is annealed in order to make concentration distribution of the elements uniform and remove a dissimilar phase when it deposits, and is then milled by, e.g., a Braun mill to obtain a roughly milled powder. The obtained powder is sieved to remove pariticles of 2 mm or more in size.

Then, Dy and Fe are weighed and then melted in an inert gas atmosphere of Ar to prepare the alloy (hereinafter referred to as Starting Material B) as one of starting materials. Starting Material B has a composition of Dy_{2.0}Fe, for example. Starting Material B is heat treated for 1 hour at 150° C. in a hydrogen gas atmosphere so as to make the hydrogen content thereof at a level of approximately 18000 ppm. Then, Starting Material B is sieved to remove pariticles of 2 mm or more in size.

Fe, as one of starting materials, is heat treated for 1 hour at 300° C. in a hydrogen gas atmosphere to reduce the oxygen content thereof, for example, from approximately 3000 ppm to approximately 1500 ppm, and is then milled by, e.g., an atomizer (hereinafter referred to as Starting Material C).

After Starting Materials A, B and C are weighed, they are milled and mixed with each other in an inert gas atmosphere of Ar gas using an atomizer, to prepare the alloy powder (starting material powder) having a composition of Tb_{0.6}Dy_{0.4}Fe_{1.88}, for example.

The resulting alloy powder is filled in a die in to a compact under a pressure of 8 tons/cm² in a transverse magnetic filed of given intensity, e.g., 12 kOe. The alloy powder is transferred in a piping system filled with a nitrogen gas to prevent oxidation. Supplying perfluoro polyether vapor or the like into the piping system is effective for improving fluidity of the alloy powder.

The compact is heated in a furnace to produce a sintered body, where temperature in the furnace is programmed to have a given profile. For example, sintering is conducted in a stable temperature range of 1150 to 1230° C., where Ar gas atmosphere is employed at the beginning of heating-up, then hydrogen gas is introduced to sinter the compact in a mixed hydrogen/argon gas atmosphere (35/65% by volume) in a stable temperature range of 1150 to 1230° C., thereafter sintering atomosphere is set to Ar gas.

The sintered body is aging-treated and then divided into pieces of given size to produce magnetostrictive element 11.

### EXAMPLE 1

The temperature characteristics of the magnetostrictive element 11, produced by the above-described method, were evaluated, where the compositional ratio x of Tb in the alloy composition represented by Formula (2) TbₓDy₍₁₋ₓ₎ was varied, as described below.

Each magnetostrictive element 11 sample had the following compositional ratio x of Tb:
Condition 1: x=0.28, Alloy composition: Tb_{0.28}Dy_{0.72}Fe_{1.875}
Condition 2: x=0.30, Alloy composition: Tb_{0.30}Dy_{0.70}Fe_{1.875}
Condition 3: x=0.32, Alloy composition: Tb_{0.32}Dy_{0.68}Fe_{1.875}
Condition 4: x=0.34, Alloy composition: Tb_{0.34}Dy_{0.66}Fe_{1.875}
Condition 5: x=0.40, Alloy composition: Tb_{0.40}Dy_{0.60}Fe_{1.875}
Condition 6: x=0.60, Alloy composition: Tb_{0.60}Dy_{0.40}Fe_{1.875}
Condition 7: x=1.00, Alloy composition: Tb_{1.00}Fe_{1.875}

Magnetostrictive elements 11, having the respective compositions shown above in the conditions 1 to 7, were rod-shaped (columnar), 7.4 mm in diameter and 3 mm in length.

Each magnetostrictive element 11 provided with the coil 12 arranged around the outer circumferential surface was measured for inductance at −20, 0, 20, 40 and 60° C. under a load in a range from 0 to 80 and from 0 to 240 kg.

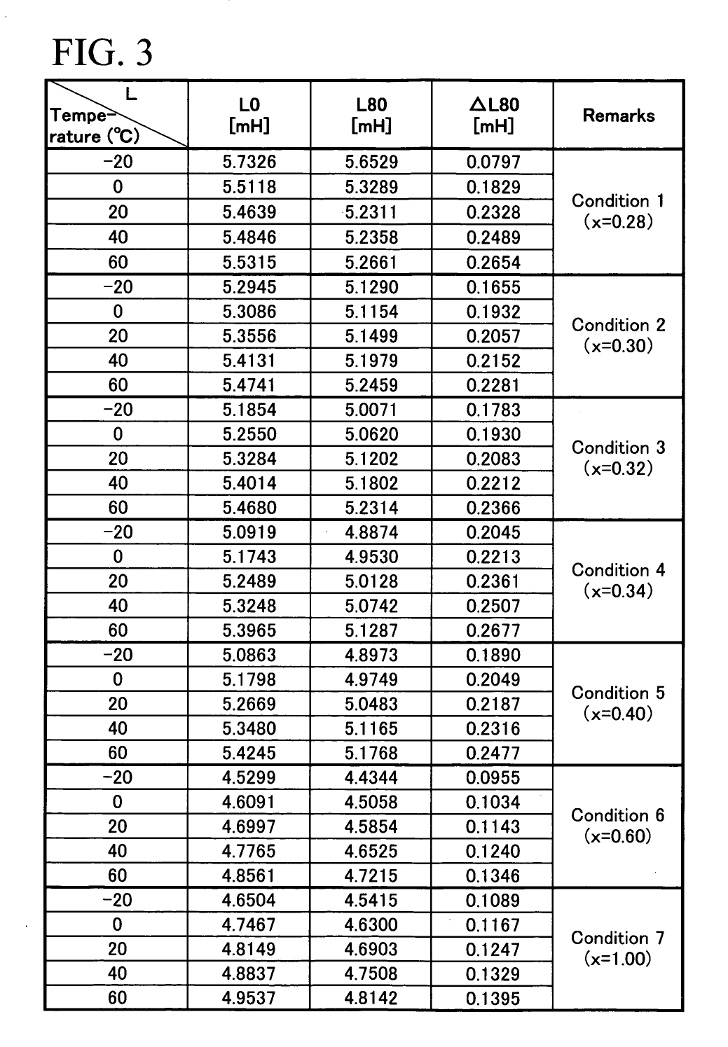

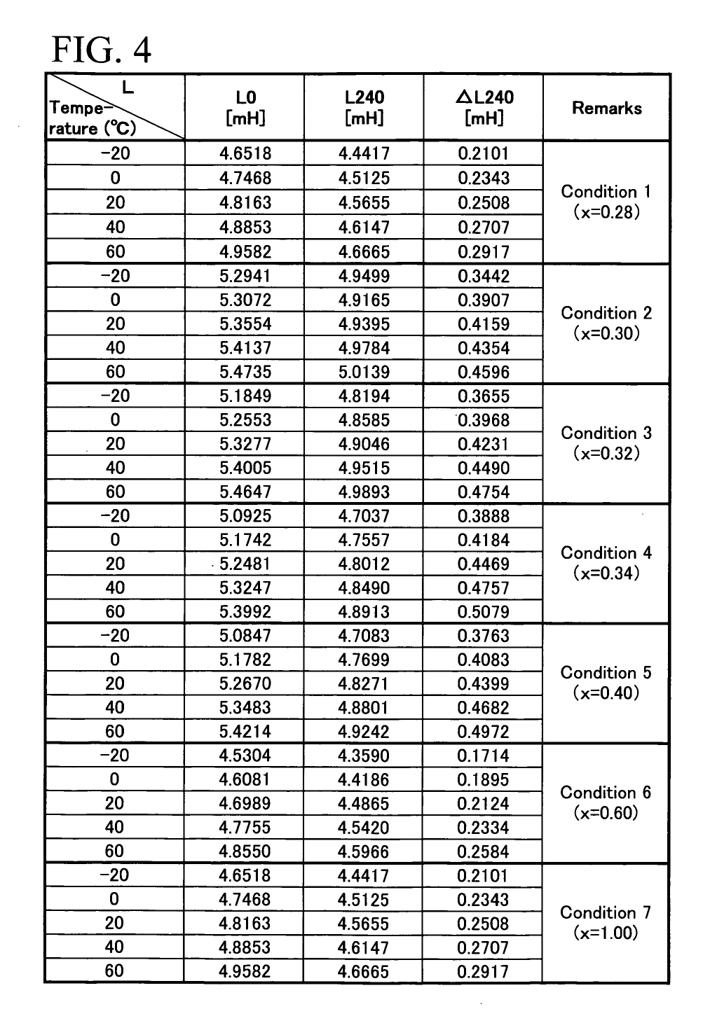

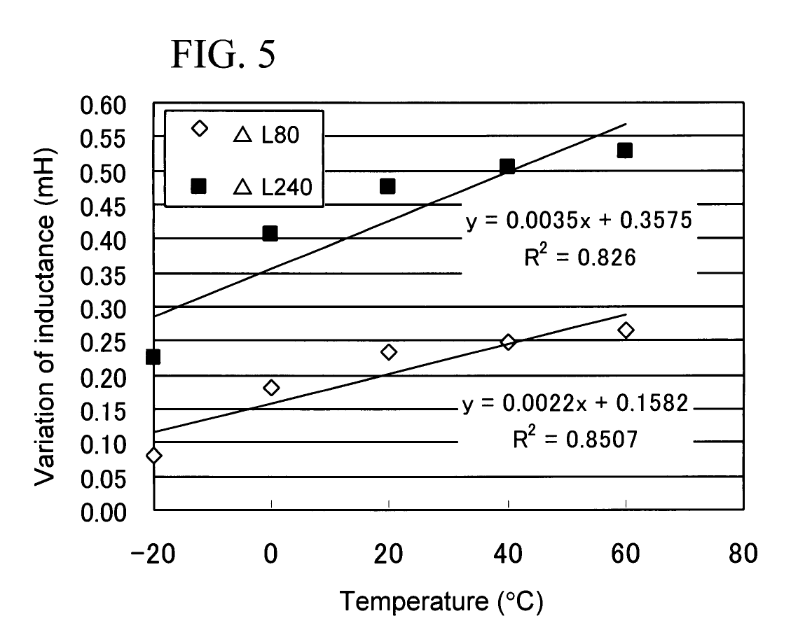

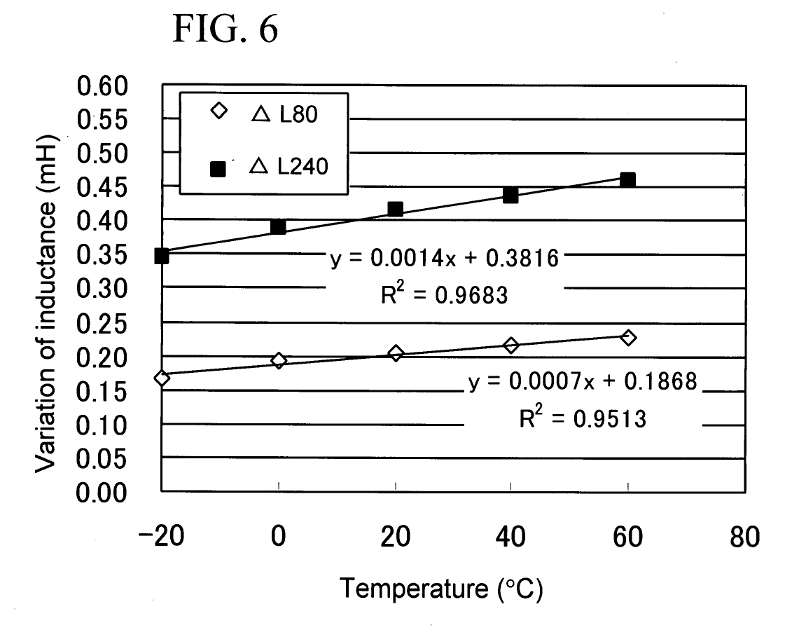

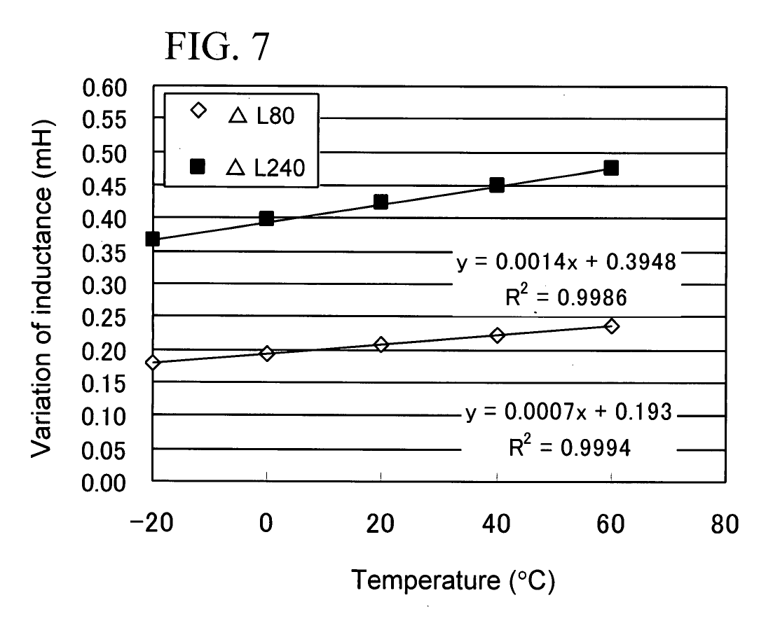

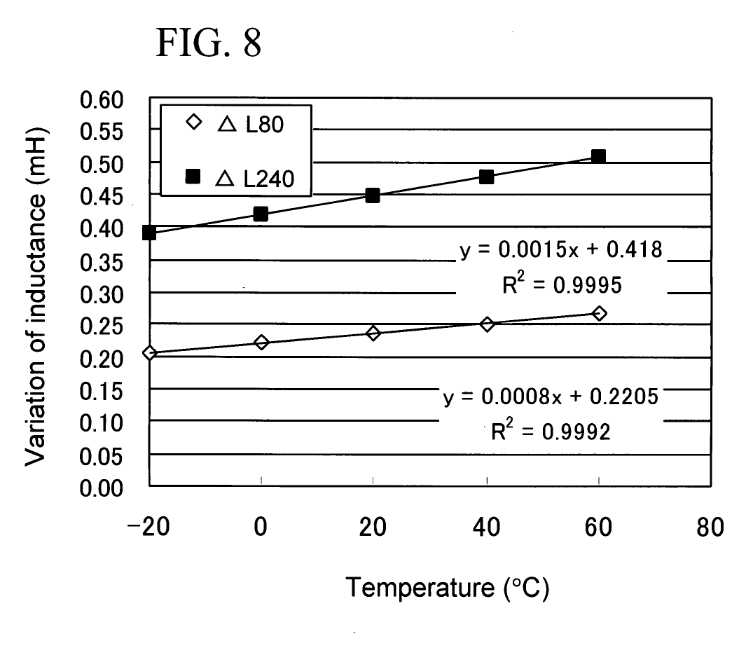

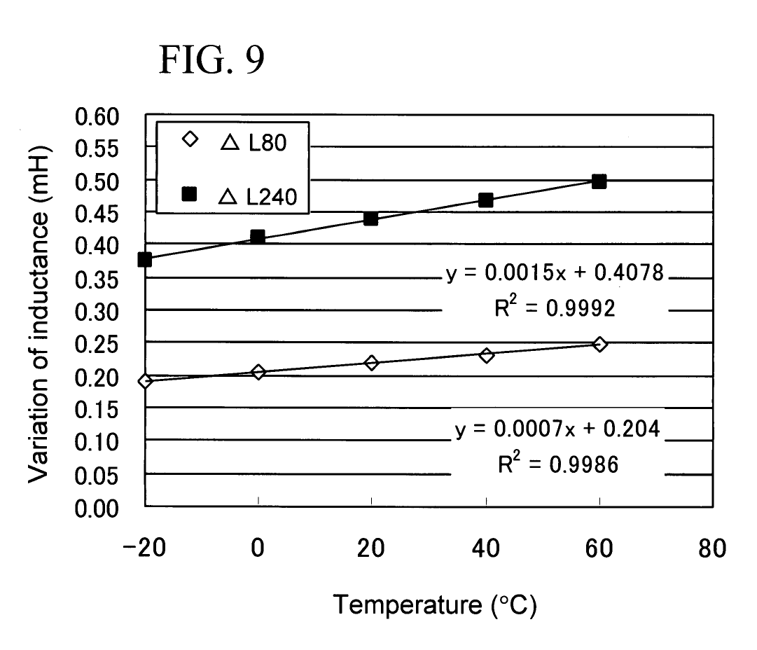

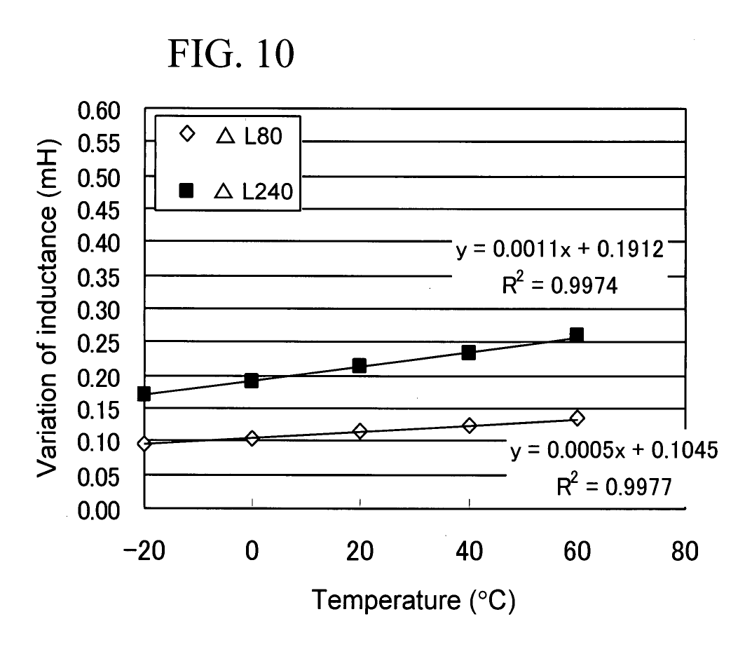

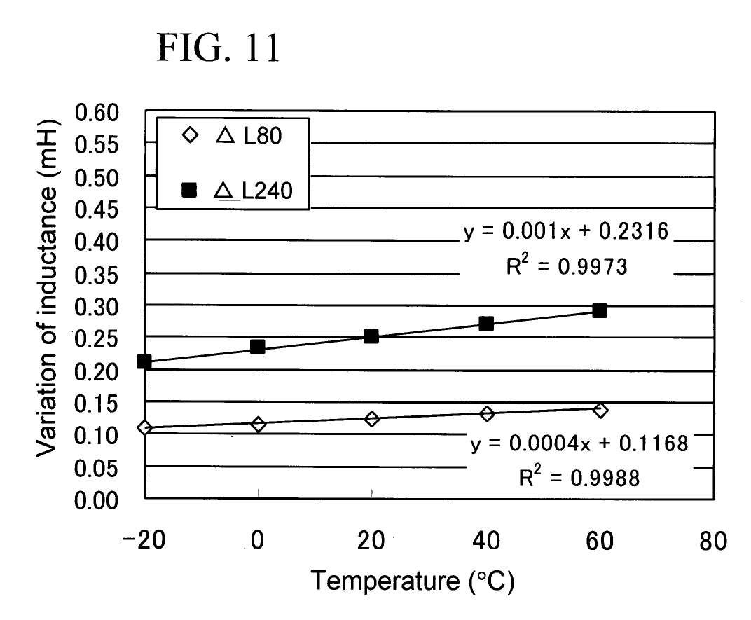

FIGS. 3 and 4 show the inductance measurement results, where a load of 0 to 80 and 0 to 240 kg was applied to each sample, respectively. FIGS. 5 to 11 give analysis results of the measurements.

In FIG. 3, “L0” represents the inductance level under a load of 0 kg, “L80” the level under a load of 80 kg, and “ΔL80” the variation of inductance as load was varied from 0 to 80 kg, i.e., the difference between the inductance levels L80 and L0. Similarly, in FIG. 4, “L0” represents the inductance level under a load of 0 kg, “L240” the level under a load of 240 kg, and “ΔL240” the variation of inductance as the load was varied from 0 to 240 kg, i.e., the difference between the inductance levels L240 and L0.

FIGS. 5 to 11 show the variation of inductances with ambient temperature at each of Conditions 1 to 7.

An approximation formula for each of the variation of inductances ΔL80 and ΔL240 with temperature was developed, based on the results shown in FIGS. 5 to 11. It is also given in each figure.

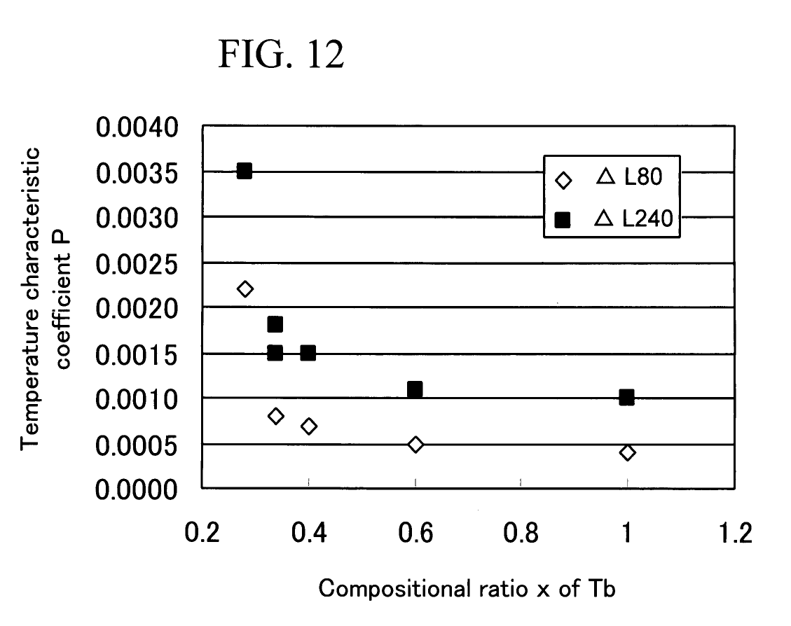

In the approximation formula y=Px+R, the coefficient P (hereinafter referred to as temperature characteristic coefficient) represents slope of the variation of inductance with varied temperature. The lower the temperature characteristic coefficient P, the more stable the magnetostrictive element with temperature. FIG. 12 plots the temperature characteristic coefficient for each of the variation of inductances ΔL80 and ΔL240 against the compositional ratio x of Tb at each of Conditions 1 to 7.

It is apparent, as shown in FIG. 12, that the temperature characteristic coefficient P is significantly lower at a Tb compositional ratio x of 0.50 or more than below 0.5.

### EXAMPLE 2

The magnetostrictive elements 11 were produced in the same manner as in Example 1, except that the above Starting Materials A, B and C were weighed and mixed with each other to have compositions as shown below (Conditions 8 to 11). Table 1 shows the temperature characteristic coefficient P obtained for ΔL80 and ΔL240 at each of Conditions 8 to 11.
Condition 8: x=0.60, Alloy composition: Tb_{0.60}Dy_{0.40}Fe_{1.5}
Condition 9: x=0.60, Alloy composition: Tb_{0.60}Dy_{0.40}Fe_{3.0}
Condition 10: x=0.70, Alloy composition: Tb_{0.70}Dy_{0.30}Fe_{1.875}

Condition 11: x=0.90, Alloy composition: Tb_{0.90}Dy_{0.10}Fe_{1.875}

TABLE 1

| | Temperature | Temperature |
|---|---|---|
| | characteristic | characteristic |
| | coefficient P | coefficient P |
| | obtained for ΔL80 | obtained for ΔL240 |
| Condition 8 | 0.0006 | 0.0012 |
| Condition 9 | 0.0007 | 0.0015 |
| Condition 10 | 0.0005 | 0.0010 |
| Condition 11 | 0.0004 | 0.0010 |

1. A sensor comprising:
a magnetostrictive element comprising a sintered body having a composition represented by TbₓDy₍₁₋ₓ₎T_{y}, wherein a is in the range: 0.50<x≦1.00, T represents one or more transition metal elements, and y is in the range: 1<y<4; and
a coil arranged on the outer circumferential side of said magnetostrictive element.

2. The sensor according to claim 1, wherein:
said coil generates an electrical signal in response to an external force working in such a direction as to compress said magnetostrictive element.

3. The sensor according to claim 2, wherein:
said sensor is a torque sensor used in an electric hybrid bicycle, and senses a pedal pressure in said electric hybrid bicycle.

4. The sensor according to claim 1, wherein:
said magnetostrictive element is columnar; and
said coil is wound around the outer circumferential surface of said magnetostrictive element.

5. The sensor according to claim 1, wherein:
said x is below 1.00.

6. A magnetostrictive element comprising a sintered body having a composition represented by TbₓDy₍₁₋ₓ₎T_{y}, wherein:
x is in the range: 0.50<x≦1.00, T represents one or more transition metal elements, and y is in the range: 1<y<4.

7. The magnetostrictive element according to claim 6, wherein:
said x is 0.50<x≦0.75.

8. An assisted bicycle comprising:
a bicycle body provided with a pedal and driven by a pedal pressure,
a sensor for generating an electrical signal in response to said pedal pressure, and
an auxiliary force generator for generating an auxiliary force in response to said electrical signal transmitted from said sensor to assist in driving said bicycle body, wherein said sensor comprises:
a magnetostrictive element having a composition represented by TbₓDy₍₁₋ₓ₎T_{y}, wherein a is in the range: 0.50<x≦1.00, T represents one or more transition metal elements, and y is in the range: 1<y<4, and varying in permeability on receiving said pedal pressure as a compressive force, and
a signal generating member generating an electrical signal in accordance with the varied permeability of said magnetostrictive element.

9. The assisted bicycle according to claim 8, wherein:
said auxiliary force generator is an electric motor.

10. The assisted bicycle according to claim 8, wherein:
said signal generating member is a coil.

11. The assisted bicycle according to claim 8, wherein:
said magnetostrictive element is columnar.

12. The assisted bicycle according to claim 8, wherein:
said x is 0.50<x≦0.75.

13. The assisted bicycle according to claim 8, wherein:
said y is 1.80≦y≦1.95.

14. A method for producing a magnetostrictive element comprising the steps of:
compacting a starting material powder in a magnetic field to prepare a compact, and
sintering said compact to prepare a sintered body having a composition represented by TbₓDy₍₁₋ₓ₎T_{y} wherein a is in the range: 0.50<x≦1.00, T represents one or more transition metal elements, and y is in the range: 1<y<4.
